(19) United States
(12) Patent Application Publication
(10) Pub. No.: US 2014/0016546 A1
(43) Pub. Date: Jan. 16, 2014

(54) METHOD AND DEVICE FOR TRANSMITTING UPLINK CONTROL INFORMATION IN WIRELESS ACCESS SYSTEM

(71) Applicants: Jiwoong Jang, Anyang-si (KR); Seunghee Han, Anyang-si (KR); Jaehoon Chung, Anyang-si (KR)

(72) Inventors: Jiwoong Jang, Anyang-si (KR); Seunghee Han, Anyang-si (KR); Jaehoon Chung, Anyang-si (KR)

(73) Assignee: LG ELECTRONICS INC., Seoul (KR)

(21) Appl. No.: 13/878,704

(22) PCT Filed: Oct. 10, 2011
(86) PCT No.: PCT/KR2011/007483

§ 371 Date: Apr. 10, 2013

Related U.S. Application Data
(60) Provisional application No. 61/391,678, filed on Oct. 10, 2010.

(51) Int. Cl. H04W 24/02

(52) U.S. Cl. CPC H04W 24/02
USPC 370/328

(57) ABSTRACT

The present invention discloses various methods and devices for transmitting uplink control information in a wireless access system which supports a carrier aggregation environment (i.e., multiple cell environment). The method for transmitting the uplink control information (UCI) in the wireless access system, according to one embodiment of the present invention, comprises the following steps: a user equipment receiving information on at least one cell, which is allocated from the multiple cell environment; the user equipment producing representative rank indicator (RI) information on the at least one cell; the user equipment performing channel encoding on the UCI including the representative RI information and uplink data; and the user equipment transmitting an physical uplink shared channel signal including the UCI, which includes the representative RI information.

### TECHNICAL FIELD

The present invention relates to a wireless access system and to methods and apparatuses for transmitting uplink control information in a carrier aggregation environment (i.e. a multi-component carrier environment). More particularly, the present invention relates to methods for transmitting rank indicator information and methods and apparatuses for applying an error detection code to uplink control information.

### BACKGROUND ART

A 3rd Generation Partnership Project Long Term Evolution (3GPP LTE; Rel-8 or Rel-9) system (hereinafter, an LTE system) adopts a Multi-Carrier Modulation (MCM) scheme using a Component Carrier (CC) by splitting a single CC into multiple bandwidths. However, a 3GPP LTE-Advanced system (hereinafter, an LTE-A system) may adopt a Carrier Aggregation (CA) scheme using CCs by aggregating one or more CCs in order to support a system bandwidth wider than that of the LTE system. The term CA may be used interchangeably with terms such as carrier matching, multi-cc environment, and multi-carrier environment.

In a single-CC environment of an LTE system rather than a multi-CC environment, only the case where Uplink Control Information (UCI) and data are multiplexed using a plurality of layers on one CC is described.

However, in a CA environment, one or more CCs may be used and the number of UCI may be increased by as many as the number of used CCs. For example, Rank Indicator (RI) information has a size of up to 2 bits or 3 bits in the LTE system. However, in the LTE-A system, a total bandwidth may be extended up to 5 CCs and, thus, the RI information may have a size of up to 15 bits.

A UCI transmission method defined in the LTE system cannot transmit UCI of a large size up to 15 bits and the UCI of such a size cannot be encoded even using an existing Reed-Muller (RM) code. Accordingly, a new method for transmitting UCI having a large size in the LTE-A system is needed.

An object of the present invention devised to solve the problem lies in a method of efficiently encoding and transmitting UCI in a multi-carrier environment (or a CA environment).

Another object of the present invention lies in a method of adjusting the amount of resources allocated to an RI by multiplexing the RI when UCI and uplink data are multiplexed using a plurality of layers in a multi-carrier environment.

Still another object of the present invention lies in a method of applying a Cyclic Redundancy Code (CRC) to UCI when UCI and uplink data are multiplexed using a plurality of layers in a multi-carrier environment.

A further object of the present invention lies in a method of mapping UCI to Resource Elements (REs) of the same number in all or a part of layers even if the UCI is not repeated when UCI and uplink data are multiplexed using a plurality of layers in a multi-carrier environment.

A still further object of the present invention lies in a transmission apparatus and/or a reception apparatus supporting the above-described methods.

It will be appreciated by persons skilled in the art that that the technical objects that can be achieved through the present invention are not limited to what has been particularly described hereinabove and other technical objects of the present invention will be more clearly understood from the following detailed description.

### DISCLOSURE

### Technical Problem

A 3rd Generation Partnership Project Long Term Evolution (3GPP LTE; Rel-8 or Rel-9) system (hereinafter, an LTE system) adopts a Multi-Carrier Modulation (MCM) scheme using a Component Carrier (CC) by splitting a single CC into multiple bandwidths. However, a 3GPP LTE-Advanced system (hereinafter, an LTE-A system) may adopt a Carrier Aggregation (CA) scheme using CCs by aggregating one or more CCs in order to support a system bandwidth wider than that of the LTE system. The term CA may be used interchangeably with terms such as carrier matching, multi-cc environment, and multi-carrier environment.

In a single-CC environment of an LTE system rather than a multi-CC environment, only the case where Uplink Control Information (UCI) and data are multiplexed using a plurality of layers on one CC is described. However, in a CA environment, one or more CCs may be used and the number of UCI may be increased by as many as the number of used CCs.

For example, Rank Indicator (RI) information has a size of up to 2 bits or 3 bits in the LTE system. However, in the LTE-A system, a total bandwidth may be extended up to 5 CCs and, thus, the RI information may have a size of up to 15 bits.

A UCI transmission method defined in the LTE system cannot transmit UCI of a large size up to 15 bits and the UCI of such a size cannot be encoded even using an existing Reed-Muller (RM) code. Accordingly, a new method for transmitting UCI having a large size in the LTE-A system is needed.

An object of the present invention devised to solve the problem lies in a method of efficiently encoding and transmitting UCI in a multi-carrier environment (or a CA environment).

Another object of the present invention lies in a method of adjusting the amount of resources allocated to an RI by multiplexing the RI with uplink data when UCI and uplink data are multiplexed using a plurality of layers in a multi-carrier environment.

Still another object of the present invention lies in a method of applying a Cyclic Redundancy Code (CRC) to UCI when UCI and uplink data are multiplexed using a plurality of layers in a multi-carrier environment.

A further object of the present invention lies in a method of mapping UCI to Resource Elements (REs) of the same number in all or a part of layers even if the UCI is not repeated when UCI and uplink data are multiplexed using a plurality of layers in a multi-carrier environment.

A still further object of the present invention lies in a transmission apparatus and/or a reception apparatus supporting the above-described methods.

It will be appreciated by persons skilled in the art that that the technical objects that can be achieved through the present invention are not limited to what has been particularly described hereinabove and other technical objects of the present invention will be more clearly understood from the following detailed description.

### Technical Solution

Embodiments of the present invention provide various methods and apparatuses for transmitting UCI in a CA environment (i.e. a multi-component carrier environment). In addition, embodiments of the present invention provide various methods for configuring and transmitting RI information and methods and apparatuses for applying an error detection code to UCI in a CA environment.

In an aspect of the present invention, a method for transmitting Uplink Control Information (UCI) at a user equipment in a wireless access system includes receiving information about one or more cells allocated in a multi-cell environment (i.e. in a carrier aggregation environment), calculating representative Rank Indicator (RI) information for the one or more cells, channel-encoding uplink data and UCI containing the representative RI information, and transmitting a Physical Uplink Shared Channel (PUSCH) signal which includes the UCI containing the representative RI information.

In another aspect of the present invention, provided herein is a method for receiving Uplink Control Information (UCI) at a base station in a wireless access system, including transmitting information about one or more cells in a multi-cell environment, and receiving a Physical Uplink Shared Channel (PUSCH) signal which includes UCI containing representative RI information for the one or more cells.

In the above aspects of the present invention, the representative RI information may be configured according to a Transport Block Size (TBS) for the one or more cells. For example, an RI value for a cell having the largest TBS or the smallest TBS may be configured as the representative RI information.

The representative RI information may be configured according to a Modulation Coding Scheme (MCS) level for the one or more cells. For example, an RI value for a cell having the highest MCS level or the smallest MCS level among the cells may be configured as the representative RI information.

The representative RI information may be configured as an RI value for a cell designated by the user equipment or the base station among the one or more cells

The above aspects of the present invention are merely some parts of the exemplary embodiments of the present invention and other embodiments into which the technical features of the present invention are incorporated can be derived and understood by those skilled in the art from the detailed description of the present invention which follows.

### Advantageous Effects

According to the embodiments of the present invention, the following effects are obtained.

First, according to the embodiments of the present invention, a UE can efficiently encode and transmit UCI in a multi-carrier environment (or in a CA environment).

Second, the UE and a BS can transmit and/or receive an RI value of a great size even when UCI and uplink data are multiplexed using a plurality of layers in a multi-carrier environment by adjusting the amount of resources allocated to an RI through multiplexing of the RI.

Third, UCI can be efficiently transmitted and received even when the UCI and uplink data are multiplexed using a plurality of layers in a multi-carrier environment by applying a CRC to the UCI.

Fourth, UCI of a great size can be transmitted and received even when the UCI and uplink data are multiplexed using a plurality of layers in a multi-carrier environment by mapping the UCI to the same number of REs in all or a part of the layers even if the UCI is not repeated.

Fifth, UCI can be efficiently transmitted by matching an RI transmission scheme to a scheme suitable for multiple CCs in a multi-CC environment.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included as a part of the detailed description to provide a further understanding of the invention, provide embodiments of the invention and together with the description serve to explain the principle of the invention. In the drawings,

FIG. 1 is a view illustrating physical channels used in a 3GPP LTE system and a general signal transmission method using the physical channels;

FIG. 2 is a view illustrating a structure of a UE and a signal processing operation for transmitting an uplink signal in the UE;

FIG. 3 is a view illustrating a structure of a BS and a signal processing operation for transmitting a downlink signal in the BS;

FIG. 4 is a view illustrating a structure of a UE and SC-FDMA and OFDMA schemes;

FIG. 5 is a view illustrating a signal mapping scheme in the frequency domain, for satisfying a single carrier property in the frequency domain;

FIG. 6 is a block diagram illustrating an RS transmission processing operation for demodulating a transmission signal according to an SC-FDMA scheme

FIG. 7 is a view illustrating a symbol location to which an RS is mapped in a subframe structure according to an SC-FDMA scheme;

FIG. 8 is a view illustrating a signal processing operation for mapping DFT processed samples to a single carrier in clustered SC-FDMA;

FIGS. 9 and 10 are views illustrating signal processing operations for mapping DFT processed samples to multiple carriers in clustered SC-FDMA

FIG. 11 is a view illustrating a signal processing operation in segmented SC-FDMA;

FIG. 12 is a view illustrating an uplink subframe structure usable in embodiments of the present invention;

FIG. 13 is a view illustrating a processing operation of UL-SCH data and control information usable in embodiments of the present invention;

FIG. 14 is a view illustrating multiplexing of UCI and UL-SCH data on a PUSCH;

FIG. 15 is a view illustrating multiplexing of control information and UL-SCH data in a Multiple Input Multiple Output (MIMO) system;

FIGS. 16 and 17 are views illustrating a plurality of UL-SCH transport blocks included in a UE and an exemplary method of multiplexing UCI and control information in the UE according to an embodiment of the present invention;

FIG. 18 is a view illustrating an exemplary method for transmitting UCI by grouping multiple CCs according to an embodiment of the present invention;

FIG. 19 is a view illustrating an exemplary method for transmitting UCI using representative RI information according to an embodiment of the present invention;

FIG. 20 is a view illustrating an exemplary method for grouping multiple CCs and selecting a representative RI value to transmit UCI according to an embodiment of the present invention; and

FIG. 21 is a view illustrating a UE and an eNB in which the embodiments of the present invention described with reference to FIGS. 1 to 20 can be performed, according to another embodiment of the present invention.

### BEST MODE

Embodiments of the present invention disclose methods and apparatuses for transmitting and receiving UCI in a CA environment (or multi-CC environment). Also, the embodiments of the present invention disclose methods for transmitting and receiving RI information and methods and apparatuses for applying an error detection code to UCI.

The embodiments of the present invention described below are combinations of elements and features of the present invention in a predetermined form. The elements or features are considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions or features of another embodiment.

In the description of the attached drawings, procedures or steps will be omitted when they may obscure the subject matter of the present invention. In addition, procedures or steps that could be understood by those skilled in the art will not be described.

In the embodiments of the present invention, a description is given of data transmission and reception between a Base Station (BS) and a terminal. Here, the BS refers to a terminal node of a network, which directly communicates with the terminal. In some cases, a specific operation described as being performed by the BS may be performed by an upper node of the BS.

Namely, it is apparent that, in a network comprised of a plurality of network nodes including a BS, various operations performed for communication with a terminal may be performed by the BS, or network nodes other than the BS. The term ‘BS’ may be replaced with terms such as fixed station, Node B, eNode B (eNB), Advanced Base Station (ABS), access point, etc.

The term ‘terminal’ may be replaced with terms such as User Equipment (UE), Mobile Station (MS), Subscriber Station (SS), Mobile Subscriber Station (MSS), mobile terminal, Advanced Mobile Station (AMS), etc.

A transmitter is a fixed and/or mobile node that provides a data service or a voice service and a receiver is a fixed and/or mobile node that receives a data service or a voice service. Therefore, in UL, an MS may serve as a transmitter and a BS may serve as a receiver. Similarly, in DL, the MS may serve as a receiver and the BS may serve as a transmitter.

The embodiments of the present invention can be supported by standard documents disclosed in at least one of wireless access systems including an Institute of Electrical and Electronic Engineers (IEEE) 802.xx system, a 3rd Generation Partnership Project (3GPP) system, a 3GPP LTE system, and a 3GPP2 system. Especially, the embodiments of the present invention can be supported by 3GPP TS 36.211, 3GPP TS 36.212, 3GPP TS 36.213, and 3GPP TS 36.321 documents. That is, obvious steps or portions that are not described in the embodiments of the present invention can be explained with reference to the above documents. In additional, for description of all terms used herein, reference can be made to the above standard documents.

Reference will now be made in detail to the exemplary embodiments of the present invention in conjunction with the accompanying drawings. The detailed description, which will be given below with reference to the accompanying drawings, is intended to explain exemplary embodiments of the present invention, rather than to show the only embodiments that can be implemented according to the invention.

In addition, specific terms used in the embodiments of the present invention are provided to aid in understanding of the present invention and those terms may be changed without departing from the spirit of the present invention.

The following technology can be used for a variety of radio access systems, for example, Code Division Multiple Access (CDMA), Frequency Division Multiple Access (FDMA), Time Division Multiple Access (TDMA), Orthogonal Frequency Division Multiple Access (OFDMA), and Single Carrier Frequency Division Multiple Access (SC-FDMA) systems.

CDMA may be embodied through radio technology such as Universal Terrestrial Radio Access (UTRA) or CDMA2000. TDMA may be embodied through radio technology such as Global System for Mobile communications (GSM)/General Packet Radio Service (GPRS)/Enhanced Data Rates for GSM Evolution (EDGE). OFDMA may be embodied through radio technology such as IEEE 802.11 (Wi-Fi), IEEE 802.16 (WiMax), IEEE 802-20, and Evolved UTRA (E-UTRA).

UTRA is a part of the Universal Mobile Telecommunications System (UMTS). 3GPP Long Term Evolution (LTE) is a part of Evolved UMTS (E-UMTS) employing E-UTRA and uses OFDMA in DL and SC-FDMA in UL. An LTE-Advanced (LTE-A) system is an evolved version of a 3GPP LTE system. To clarify description of technical features of the present invention, although 3GPP LTE/LTE-A is mainly described, the technical sprit of the present invention may be applied to IEEE 802.16e/m systems.

1. General 3GPP LTE/LTE-A System

In a wireless access system, a UE receives information from a BS through a downlink (DL) and transmits information to the BS through uplink (UL). Information that the BS and the UE transmit and receive includes general data information and various control information. A variety of control channels is present according to types/purposes of information that the BS and UE transmit and receive.

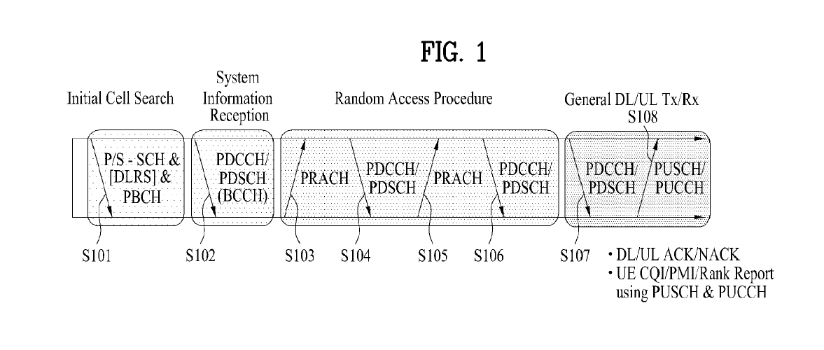

FIG. 1 illustrates physical channels used in a 3GPP LTE system and a general signal transmission method using the physical channels.

When a UE is powered on from a power-off state or enters a new cell, the UE performs initial cell search such as synchronization adjustment with a BS in step S101. To this end, the UE receives a Primary Synchronization Channel (P-SCH) and a Secondary Synchronization Channel (S-SCH) from the BS to establish synchronization with the BS and acquires information such as a cell identity (ID).

Thereafter, the UE may receive a Physical Broadcast Channel (PBCH) from the BS to thus acquire broadcast information within the cell. In the mean time, the UE may determine a downlink channel status by receiving a Downlink Reference Signal (DL RS) during the initial cell search.

After the initial cell search, the UE may acquire more specific system information by receiving a Physical Downlink Control Channel (PDCCH) and receiving a Physical Downlink Shared Channel (PDSCH) based on information of the PDCCH in step S102.

Next, in order to complete access to the BS, the UE may perform a random access procedure as indicated in steps S103 to S106. To this end, the UE may transmit a preamble through a Physical Random Access Channel (PRACH) (S103) and receive a response message to the preamble through the PDCCH and the PDSCH corresponding to the PDCCH (S104). If the random access procedure is contention-based, the UE may additionally perform a contention resolution procedure such as transmission of a PRACH signal (S105) and reception of a PDCCH signal and a PDSCH signal corresponding to the PDCCH signal (S106).

The UE which has performed the above procedures may then receive a PDCCH signal and/or a PDSCH signal (S107) and transmit a Physical Uplink Shared Channel (PUSCH) signal and/or a Physical Uplink Control Channel (PUCCH) signal (S108), as a general UL/DL signal transmission procedure.

Control information that the UE transmits to the BS is referred to as Uplink Control Information (UCI). UCI includes a Hybrid Automatic Repeat and request (HARQ) Acknowledgement/Negative Acknowledgement (ACK/NACK) signal, a Scheduling Request (SR), Channel Quality Information (CQI), a Precoding Matrix Index (PMI), a Rank Indicator (RI), and the like.

In the LTE system, while UCI is generally transmitted through the PUCCH, UCI may be transmitted through the PUSCH in the case where control information and traffic data should be simultaneously transmitted. In addition, UCI may be aperiodically transmitted through the PUSCH at the request/command of a network.

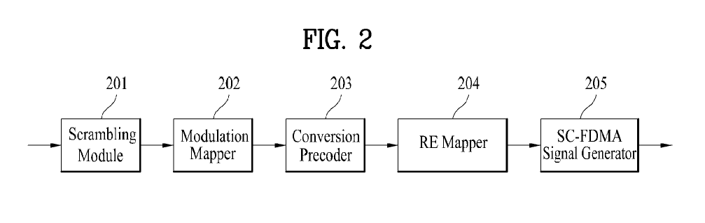

FIG. 2 is a view illustrating a structure of a UE and a signal processing operation for transmitting an uplink signal in the UE.

A scrambling module 210 may scramble a transmission signal using a UE-specific scrambling signal in order to transmit an uplink signal. A modulation mapper 220 modulates the scrambled signal to complex modulation symbols using Binary Phase Shift Keying (BPSK), Quadrature Phase Shift Keying (QPSK), or 16 Quadrature Amplitude Modulation (QAM)/64 QAM according to the type of the transmission signal and/or a channel state. A precoder 230 processes the complex modulation symbols. An RE mapper 240 may map the complex modulation symbols to time-frequency REs. After being processed in an SC-FDMA signal generator 250, the mapped signal may be transmitted to a BS through an antenna.

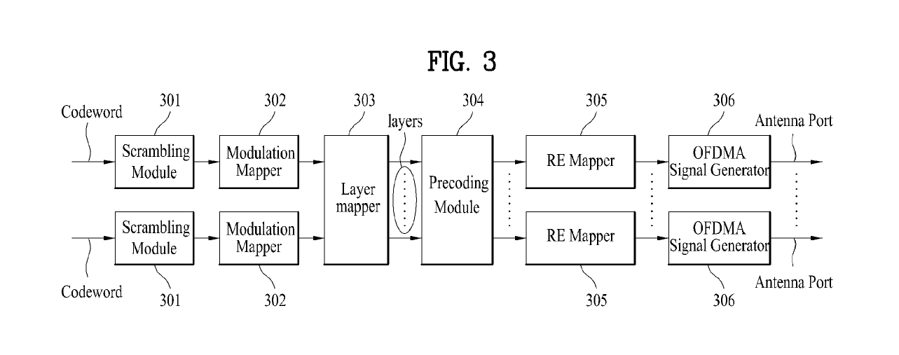

FIG. 3 is a view illustrating a structure of a BS and a signal processing operation for transmitting a downlink signal in the BS.

In a 3GPP LTE system, the BS may transmit one or more codewords on downlink. Scrambling modules 301 and modulation mappers 302 may process the codewords into complex symbols, as in uplink of FIG. 3. A layer mapper 303 maps the complex symbols to a plurality of layers. A precoding module 304 may multiply the layers by a precoding matrix and may allocate the multiplied signals to respective transmission antennas. RE mappers 305 map the antenna-specific transmission signals processed by the precoding module 304 to time-frequency REs. After being processed in OFDMA signal generators 306, the mapped signals may be transmitted through the respective antennas.

In the wireless communication system, uplink signal transmission from a UE is more problematic than downlink signal transmission from a BS in terms of Peak-to-Average Power Ratio (PAPR). Accordingly, SC-FDMA is adopted for uplink signal transmission, unlike OFDMA used for downlink signal transmission as described above with reference to FIGS. 2 and 3.

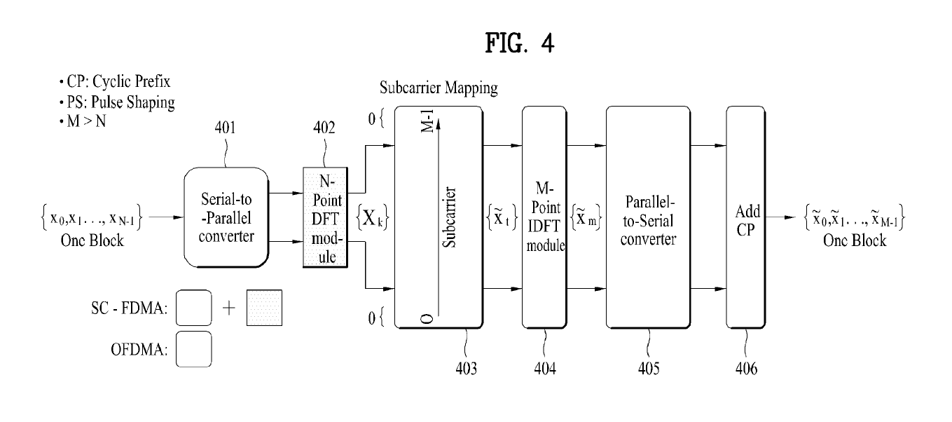

FIG. 4 is a view illustrating a structure of a UE and SC-FDMA and OFDMA schemes.

The 3GPP system (e.g. LTE system) adopts OFDMA on downlink and SC-FDMA on uplink. Referring to FIG. 4, a UE for uplink signal transmission and a BS for downlink signal transmission commonly have a serial-to-parallel converter 401, a subcarrier mapper 403, an M-point Inverse Discrete Fourier Transform (IDFT) module 404, and a Cyclic Prefix (CP) addition module 406.

Nonetheless, the UE further includes an N-point Discrete Fourier Transform (DFT) module 402 to transmit an uplink signal in SC-FDMA. The N-point DFT module 402 partially offsets the effects of IDFT performed by the M-point IDFT module 404 so that a transmission signal may have a single carrier property.

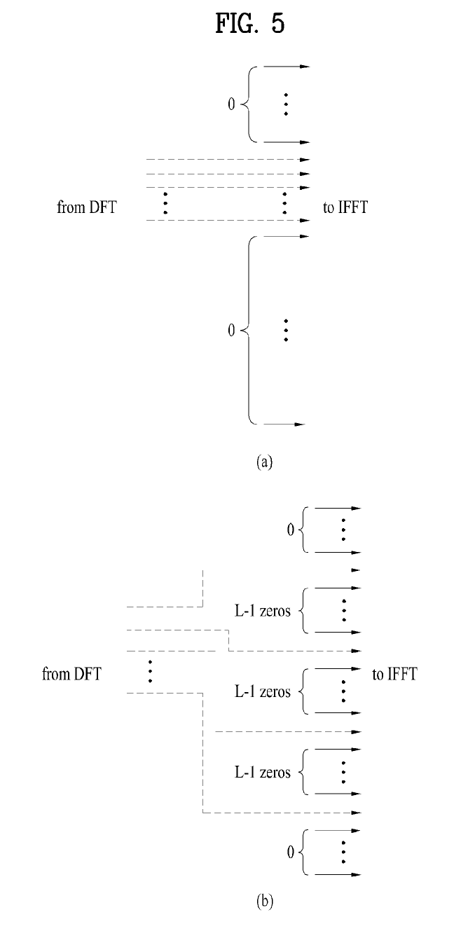

FIG. 5 is a view illustrating a signal mapping scheme in the frequency domain, for satisfying a single carrier property in the frequency domain.

FIG. 5(a) illustrates localized mapping and FIG. 5(b) illustrates distributed mapping. In clustered SC-FDMA which is a modified version of SC-FDMA, DFT processed output samples are divided into sub-groups and the sub-groups are discontinuously mapped in the frequency domain (or subcarrier domain), during a subcarrier mapping process.

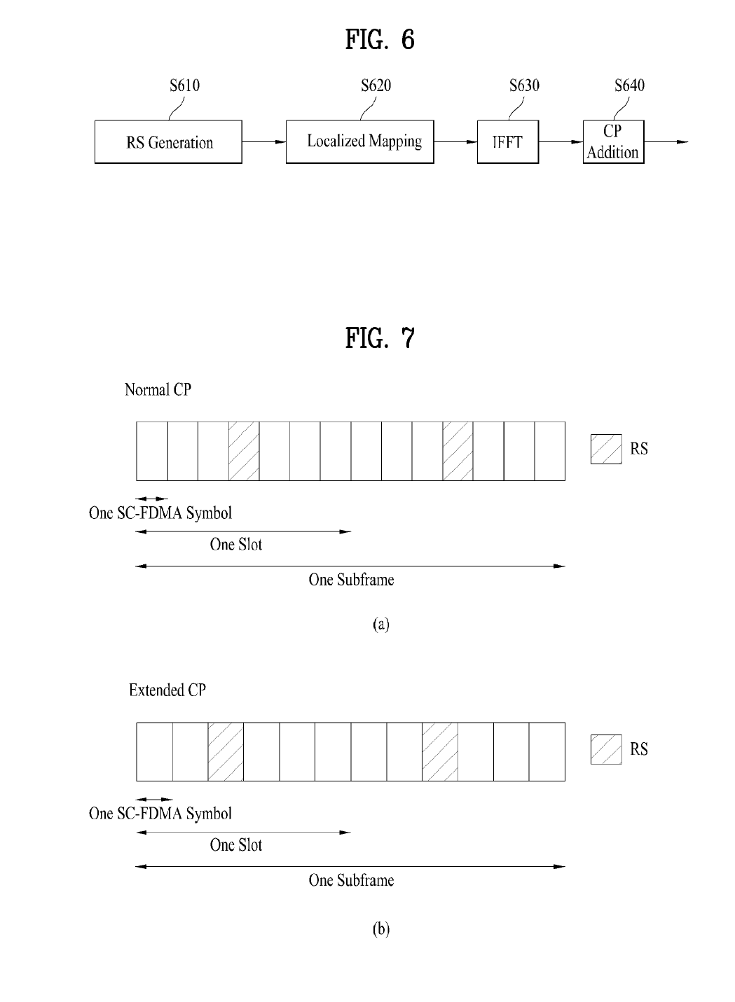

FIG. 6 is a block diagram illustrating an RS transmission processing operation for demodulating a transmission signal according to an SC-FDMA scheme.

According to LTE standard (e.g. 3GPP release-8), while a data part of a signal generated in the time domain is converted into a frequency-domain signal through DFT processing, is mapped to a signal on subcarriers, and then is transmitted through IFFT processing (see FIG. 4), an RS is directly generated in the frequency domain (S610) without DFT processing and then the RS is transmitted through sequential processes of mapping on subcarriers (S620), IFFT processing (S630), and CP addition (S640).

FIG. 7 is a view illustrating a symbol location to which an RS is mapped in a subframe structure according to an SC-FDMA scheme.

FIG. 7(a) illustrates the case where RSs are located in the fourth SC-FDMA symbol of each of two slots in one subframe in a normal CP. FIG. 7(b) illustrates the case where RSs are located in the third SC-FDMA symbol of each of two slots in one subframe in an extended CP.

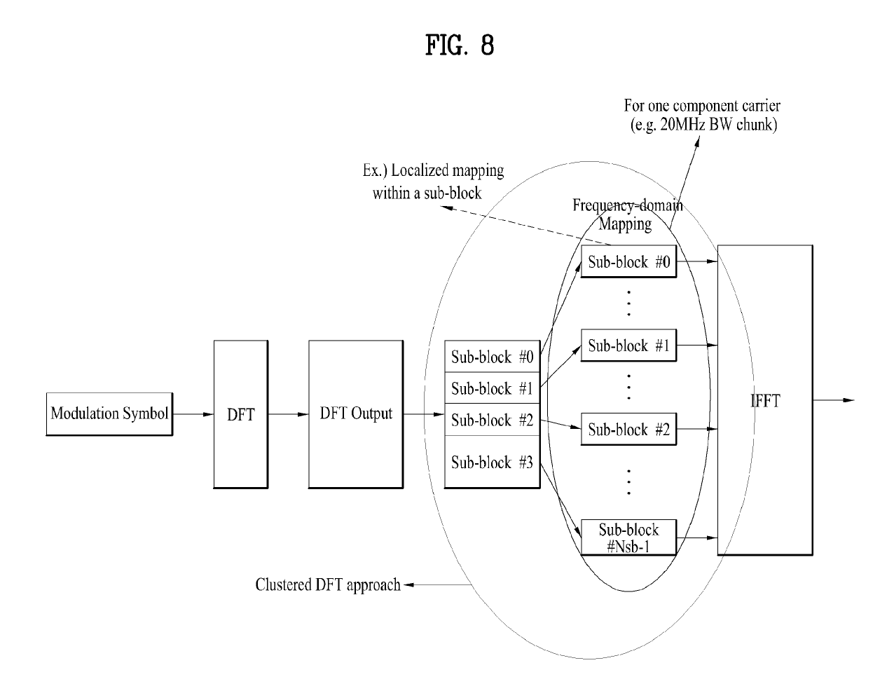

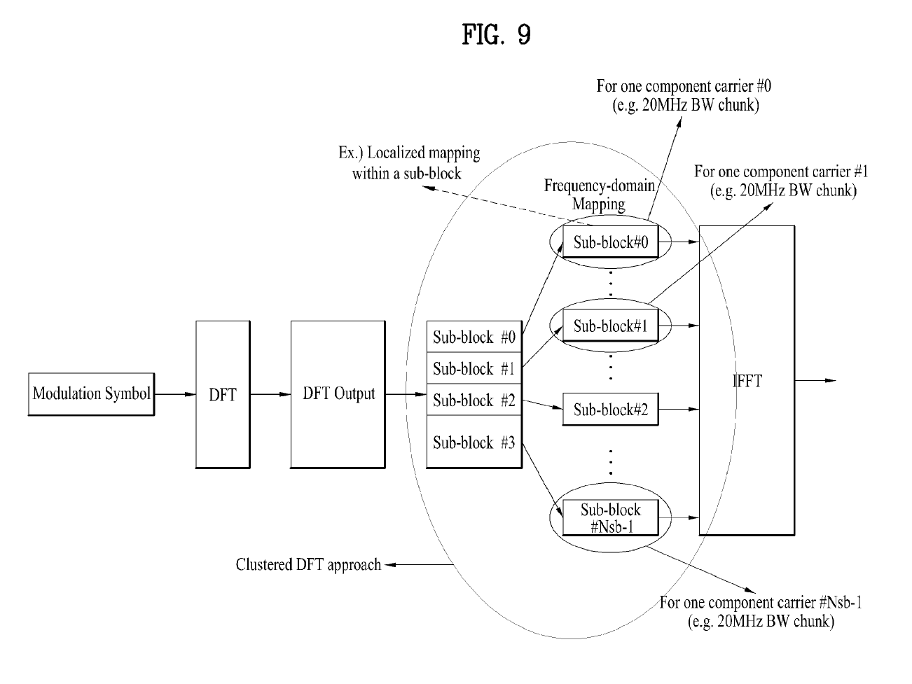

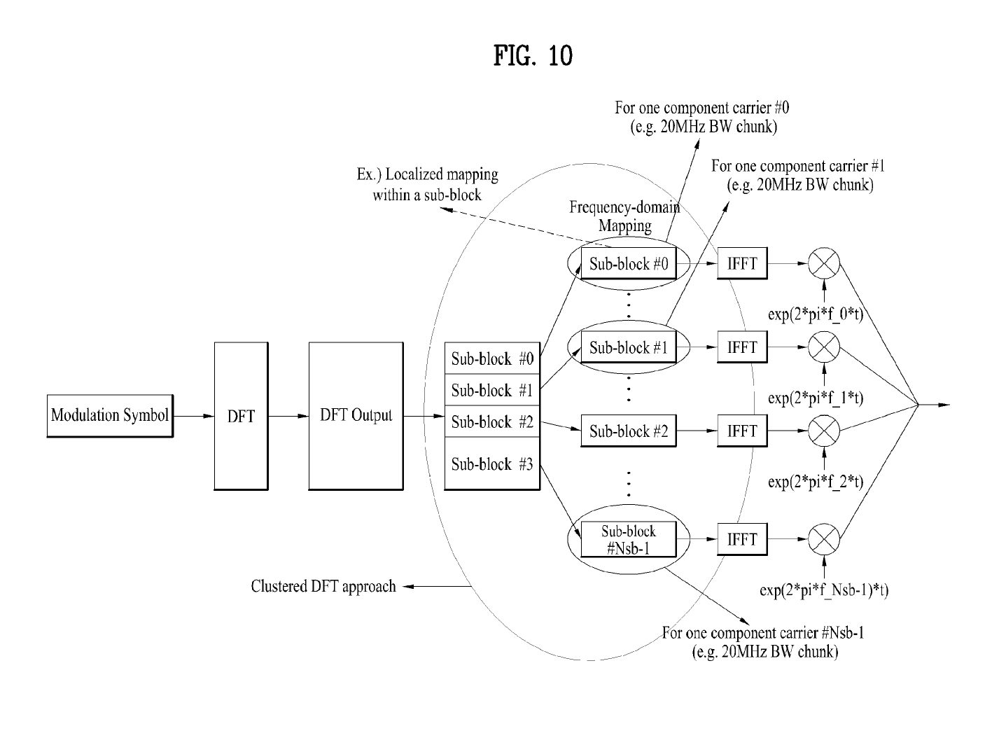

FIG. 8 is a view illustrating a signal processing operation for mapping DFT processed samples to a single carrier in clustered SC-FDMA. FIGS. 9 and 10 are views illustrating signal processing operations for mapping DFT processed samples to multiple carriers in clustered SC-FDMA.

FIG. 8 illustrates the application of intra-carrier clustered SC-FDMA, whereas FIGS. 9 and 10 illustrate the application of inter-carrier clustered SC-FDMA. FIG. 9 illustrates signal generation through a single IFFT block in the case of alignment of a subcarrier spacing between contiguous CC subcarriers in a situation in which CCs are contiguously allocated in the frequency domain. FIG. 10 illustrates signal generation through a plurality of IFFT blocks in a situation in which CCs are non-contiguously allocated in the frequency domain.

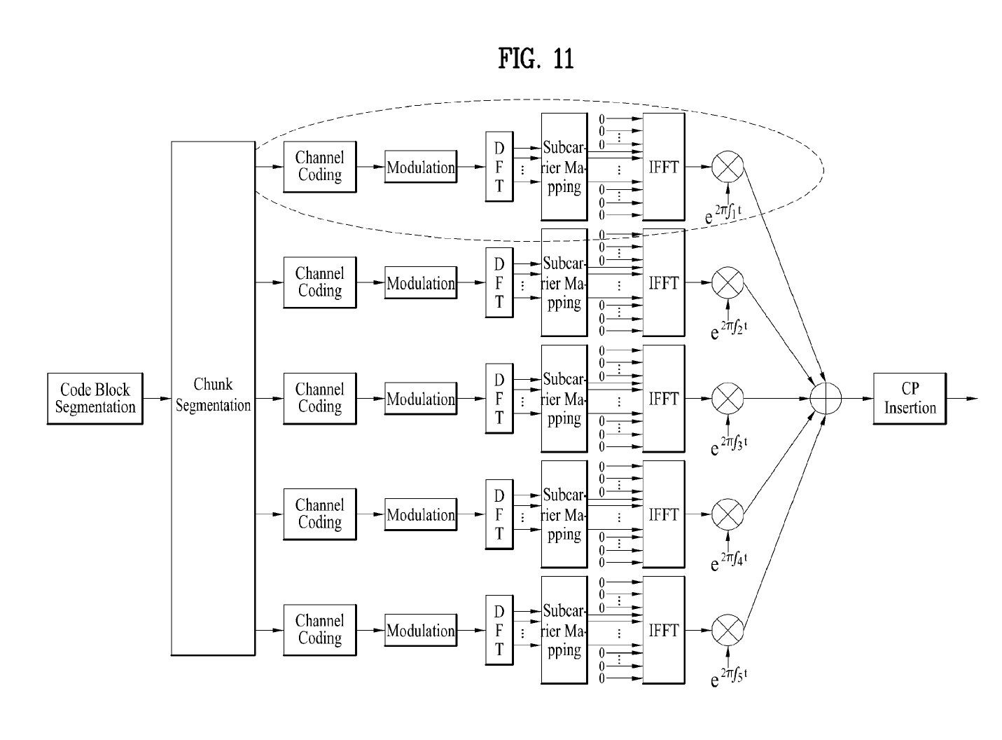

FIG. 11 illustrates a signal processing operation in segmented SC-FDMA.

As the number of DFT blocks is equal to the number of IFFT blocks and thus the DFT blocks and the IFFT blocks are in one-to-one correspondence, segmented SC-FDMA is a simple extension of DFT spreading and IFFT subcarrier mapping of conventional SC-FDMA and may be expressed as NxSC-FDMA or NxDFT-s-OFDMA. In this disclosure, segmented SC-FDMA includes all these terms. Referring to FIG. 11, in segmented SC-FDMA, all modulation symbols in the time domain are divided into N groups (where N is an integer greater than 1) and subjected to a DFT process in units of a group in order to relieve single carrier property constraints

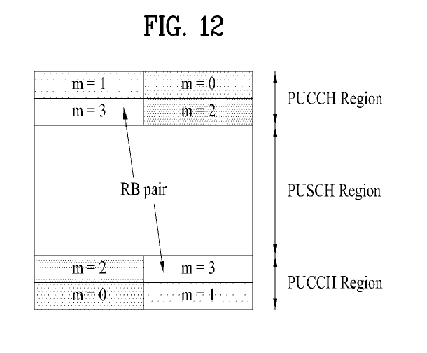

FIG. 12 illustrates an uplink subframe structure usable in embodiments of the present invention.

Referring to FIG. 12, an uplink subframe includes multiple (e.g. two) slots. A slot may include a different number of SC-FDMA symbols according to the length of a CP. For example, in case of a normal CP, a slot may include 7 SC-FDMA symbols.

The uplink subframe is divided into a data region and a control region. The data region is a region in which a PUSCH signal is transmitted and received and is used to transmit data signals such as voice signals. The control region is a region in which a PUCCH signal is transmitted and received and is used to transmit control information.

The PUCCH includes an RB pair (e.g. m=0,1,2,3) located at both ends of the data region in the frequency domain. In addition, the PUCCH includes an RB pair (e.g. an RB pair of a frequency mirrored location) located at opposite end parts in the frequency domain and the RB pair is hopped on a slot basis. UCI includes HARQ ACK/NACK, CQI, PMI, and RI.

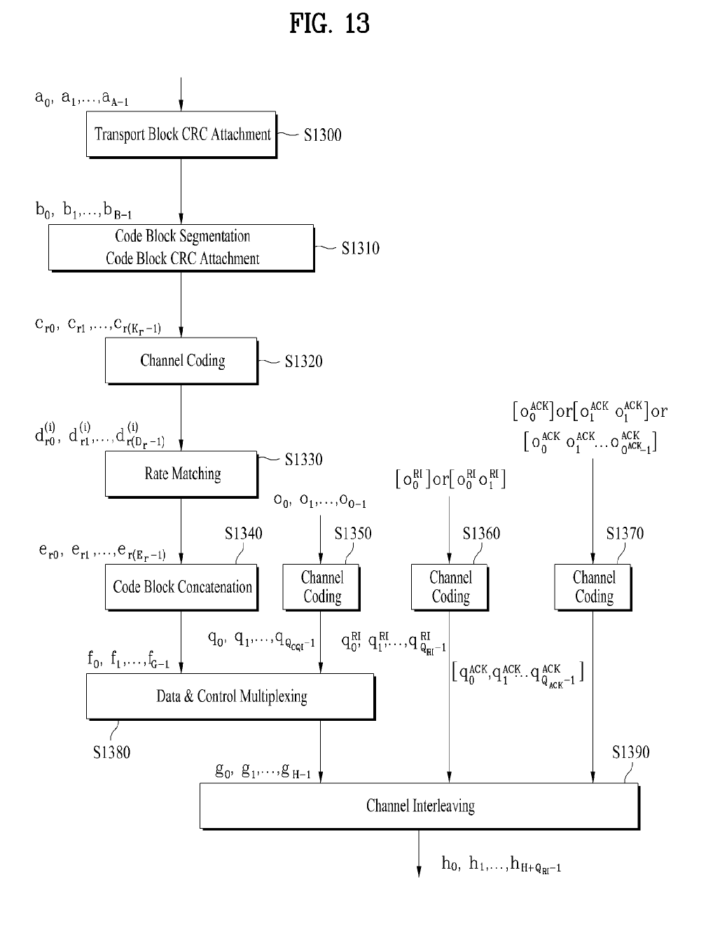

FIG. 13 illustrates a processing operation of UL-SCH data and control information usable in embodiments of the present invention.

Referring to FIG. 13, a CRC is used to provide error detection on a UL-SCH transport block (S1300).

The entire transport block is used to calculate CRC parity bits. Bits of the transport block are a₀,a₁,a₂,a₃, . . . , a_{A-1}. Parity bits are p₀,p₁,p₂,p₃, . . . , p_{L-1}. The size of the transport block is A and the number of parity bits is L(=24).

Code block segmentation and code block CRC attachment are performed after the CRC is attached to the transport block (S1310). Bits input for code block segmentation are b₀,b₁,b₂,b₃, . . . , b_{B-1}. In this case, B is the number of bits of the transport block (including the CRC). Bits provided after code block segmentation are cᵣ₀,cᵣ₁,cᵣ₂,cᵣ₃, . . . , c_{r(K}_{ᵣ}₋₁₎ where r is a code block number (r=0, 1, . . . , C−1) and Kr is the number of bits of the code block r. C denotes the total number of code blocks.

Channel coding is performed after code block segmentation and code block CRC attachment (S1320). Bits after channel coding are dᵣ₀⁽ⁱ⁾,dᵣ₁⁽ⁱ⁾,dᵣ₂⁽ⁱ⁾,dᵣ₃⁽ⁱ⁾, . . . d_{r(D}_{ᵣ}₋₁₎⁽ⁱ⁾ where i=0, 1, 2, Dᵣ is the number of bits of an i-th coded stream for the code block r (i.e. Dᵣ=Kᵣ+4), r is a code block number (r=0, 1, . . . , C−1), Kr is the number of bits of the code block r, and C is the total number of code blocks. Turbo coding may be used for channel coding.

Rate matching is performed after channel coding (S1330). Bits after rate matching are eᵣ₀,eᵣ₁,eᵣ₂,eᵣ₃, . . . , e_{r(E}_{ᵣ}₋₁₎ where Eᵣ is the number of rate-matched bits of an r-th code block, r=0, 1, . . . , C−1, and C is the total number of code blocks.

Code block concatenation is performed after rate matching (S1340). Bits after code block concatenation are f₀,f₁,f₂,f₃, . . . , f_{G-1}, where G is the total number of coded bits for transmission. When control information is multiplexed with UL-SCH transmission, bits used for control information transmission are not included in G. The bits f₀,f₁,f₂,f₃, . . . , f_{G-1} correspond to UL-SCH codewords.

In the case of UCI, channel quality information (CQI and/or PMI), RI, and HARQ-ACK are independently channel-coded (S1350, S1360, and S1370). Channel coding of the UCI is performed based on the number of coded symbols for each unit of control information. For example, the number of coded symbols may be used for rate matching of coded control information. The number of coded symbols corresponds to the number of modulation symbols or the number of REs in subsequent processes.

Channel coding of CQI is performed using an input sequence o₀,o₁,o₂, . . . , o_{O-1} (S1350). An output sequence of channel coding for CQI is q₀,q₁,q₂,q₃, . . . , q_{Q}_{_{CQI}}₋₁ A channel coding scheme applied to CQI varies with the number of bits. When the number of bits of the CQI is above 11 bits, an 8-bit CRC is attached. Q_{CQI} denotes the total number of encoded bits. To match the length of a bit sequence to Q_{CQI}, the encoded CQI may be rate-matched. Q_{CQI=}Q′_{CQI}×Qₘ, Q′_{CQI} is the number of encoded symbols for the CQI, and Qₘ is a modulation order. Qₘ is equally set to that of UL-SCH data.

Channel coding of an RI is performed using an input sequence [o₀^{RI}] or [o₀^{RI} o₁^{RI}] (S1360). [o₀^{RI}] and [o₀^{RI} o₁^{RI}] indicate a 1-bit RI and a 2-bit RI, respectively.

Repetition coding is used for the 1-bit RI. For the 2-bit RI, encoding is performed using a (3,2) simplex code and the encoded data may be cyclically repeated. For a 3-bit to 11-bit RI, encoding is performed using a (32,O) RM code used in an uplink shared channel. For more than 12-bit RI, RI information is divided into two groups using a dual RM structure and each group is encoded using a (32,O) RM code. An output bit sequence q₀^{RI},q₁^{RI},q₂^{RI}, . . . , q_{Q}_{_{RI−I}}^{RI} is obtained by concatenation of encoded RI blocks where Q_{RI} is the total number of encoded bits. The last concatenated encoded RI block may be partial so that the length of the encoded RI is equal to Q_{RI} (i.e. rate matching). Q_{RI}=Q′_{RI}×Qₘ,Q′_{RI} is the number of encoded symbols for the RI, and Qₘ is a modulation order. Qₘ is equally set to that of UL-SCH data.

Channel coding of a HARQ-ACK is performed using an input sequence [o₀^{ACK}] [o₀^{ACK} o₁^{ACK}], or [o₀^{ACK} o₁^{ACK} . . . o_{O}_{^{ACK}}₋₁^{ACK}] of step S1370. [o₀^{ACK}] and [o₀^{ACK} o₁^{ACK}] indicate a 1-bit HARQ-ACK and a 2-bit HARQ-ACK, respectively. [o₀^{ACK} o₁^{ACK} . . . o_{O}_{^{ACK}}₋₁^{ACK}] indicates a HARQ-ACK consisting of information of two bits or more (i.e. O^{ACK}>2) ACK is encoded to 1 and NACK is encoded to 0. Repetition coding is used for the 1-bit HARQ-ACK. For the 2-bit HARQ-ACK, encoding is performed using a (3,2) simplex code and the encoded data may be cyclically repeated. For a 3-bit to 11-bit HARQ-ACK, encoding is performed using a (32,O) RM code used in an uplink shared channel. For more than 12-bit HARQ-ACK, HARQ-ACK information is divided into two groups using a dual RM structure and each group is encoded using a (32,O) RM code. Q_{ACK} denotes the total number of encoded bits. A bit sequence q₀^{ACK},q₁^{ACK},q₂^{ACK}, . . . , q_{Q}_{_{ACK}}₋₁^{ACK} is obtained by concatenation of encoded HARQ-ACK blocks. The last concatenated encoded HARQ-ACK block may be partial so that the length of bit sequences is equal to Q_{ACK} (i.e. rate matching). Q_{ACK=}Q′_{ACK}×Qₘ, Q′_{ACK} is the number of encoded symbols for the HARQ-ACK, and Qₘ is a modulation order. Qₘ is equally set to that of UL-SCH data.

Inputs of a data/control multiplexing block are encoded UL-SCH bits f₀,f₁,f₂,f₃, . . . , f_{G-1} and encoded CQI/PMI bits q₀,q₁,q₂,q₃, . . . , q_{Q}_{_{CQI}}₋₁ (S1380). An output of the data/control multiplexing block is g₀,g₁,g₂,g₃, . . . , g_{H′-1} where gᵢ (i=0, . . . , H′−1) is a column vector of length Qₘ, H′=H/Qₘ, H=(G+Q_{CQI}), and H is the total number of encoded bits allocated for UL-SCH data and CQI/PMI.

Channel interleaving is performed with respect to the output of the data/control multiplexing block, ghd 0,g₁,g₂, . . . , g_{H′-1}, the encoded RI q₀^{RI},q₁^{RI},q₂^{RI}, . . . , q_{Q′}_{_{RI}}₋₁^{RI}, and the encoded HARQ-ACK q₀^{ACK},q₁^{ACK},q₂^{ACK}, . . . , q_{Q′}_{_{ACK}}₋₁^{ACK}. gᵢ (i=0, . . . , H′−1) is a column vector of length Qₘ (H′=H/Qₘ). qᵢ^{ACK} (i=0, . . . , Q′_{ACK}−1) is a column vector of length Qₘ for ACK/NACK (Q′_{ACK}=Q_{ACK}/Qₘ). qᵢ^{RI} (i=0, . . . , Q′_{RI}−1) is a column vector of length Qₘ for an RI (Q′_{RI}=Q_{RI}/Qₘ).

A channel interleaver multiplexes control information and UL-SCH data for PUSCH transmission. Specifically, channel interleaving includes a process of mapping of control information and UL-SCH data to channel interleaver matrices corresponding to PUSCH resources.

After channel interleaving is performed, a bit sequence h₀, h₁, h₂ , . . . , h_{H+Q}_{_{RI}}₋₁ read from the channel interleaver matrix row by row is generated. The read bit sequence is mapped onto a resource grid. H″(=H′+Q′_{RI}) modulation symbols are transmitted through a subframe.

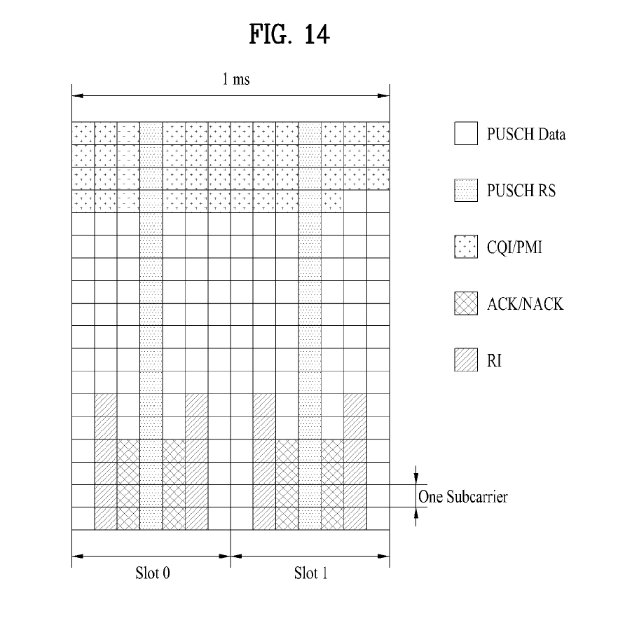

FIG. 14 illustrates multiplexing of UCI and UL-SCH data on a PUSCH.

If it is desired to transmit control information in a subframe to which PUSCH transmission is allocated, a UE multiplexes the UCI and UL-SCH data prior to DFT spreading. The UCI includes at least one of CQI/PMI, HARQ ACK/NACK, and RI.

The number of REs used for transmission of each of CQI/PMI, HARQ ACK/NACK, and RI depends on a Modulation and Coding Scheme (MCS) and an offset value (Δ_{offset}^{CQI}, Δ_{offset}^{HARQ-ACK}, or Δ_{offset}^{RI}). The offset value permits a different coding rate according to control information and is semi-statically configured by higher layer (e.g. RRC layer) signaling. The UL-SCH data and UCI are not mapped to the same RE. The UCI is mapped to be present in two slots of a subframe. Since a BS can pre-recognize that control information will be transmitted through a PUSCH, the BS may easily demultiplex the control information and data packets.

Referring to FIG. 14, CQI and/or PMI (CQI/PMI) resources are located at the beginning part of UL-SCH data resources and are sequentially mapped to all SC-FDMA symbols on one subcarrier and then to symbols on the next subcarrier. The CQI/PMI resources are mapped starting from left to right in each subcarrier, namely, in the direction of ascending SC-FDMA symbol index. PUSCH data (UL-SCH data) is rate-matched in consideration of the amount of CQI/PMI resources (i.e. the number of encoded symbols). A modulation order which is the same as the modulation order of the UL-SCH data is used for CQI/PMI.

For example, if the amount of CQI/PMI information (payload size) is small (e.g. 11 bits or less), the CQI/PMI information may use a (32,k) block code in a similar way to PUCCH transmission and encoded data may be cyclically repeated. A CRC is not used when the size of CQI/PMI information is small.

If the size of CQI/PMI information is large (e.g. 11 bits or more), an 8-bit CRC is attached and channel coding and rate matching are performed using a tail-biting convolutional code. ACK/NACK is inserted through puncturing into a portion of SC-FDMA resources to which the UL-SCH data is mapped. ACK/NACK is located next to an RS and is filled from the bottom to top of a corresponding SC-FDMA symbol, i.e. in the direction of ascending a subcarrier index.

In a normal CP, SC-FDMA symbols for ACK/NACK are located at SC-FDMA symbols #2/#4 in each slot as shown in FIG. 14. Irrespective of whether ACK/NACK is actually transmitted in a subframe, an encoded RI is located next to the symbol for ACK/NACK (i.e. at symbols #1/#5). ACK/NACK, RI and CQI/PMI are independently encoded.

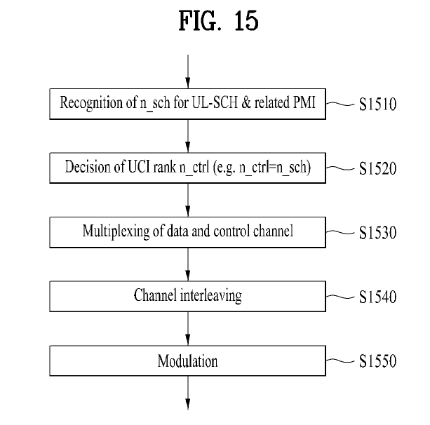

FIG. 15 is a view illustrating multiplexing of control information and UL-SCH data in a Multiple Input Multiple Output (MIMO) system.

Referring to FIG. 15, a UE recognize a rank n_sch for a UL-SCH (data part) and a PMI related to the UL-SCH data from scheduling information for PUSCH transmission (S1510). The UE determines a rank n_ctrl for UCI (S1520). The rank of the UCI may be the same as the rank of the UL-SCH data (n_ctrl=n_sch) but is not limited thereto. Next, the data and the control channel are multiplexed (S1530). A channel interleaver performs time-first mapping of the data/CQI and maps ACK/NACK/RI by performing puncturing in the vicinity of a DM-RS (S1540). The data and the control channel are then modulated according to an MCS table (S1550). An MCS includes, for example, QPSK, 16 QAM, or 64 QAM. The order/location of a modulation block may be changed (e.g. to a position prior to the ‘Multiplexing of data and control channel’ block).

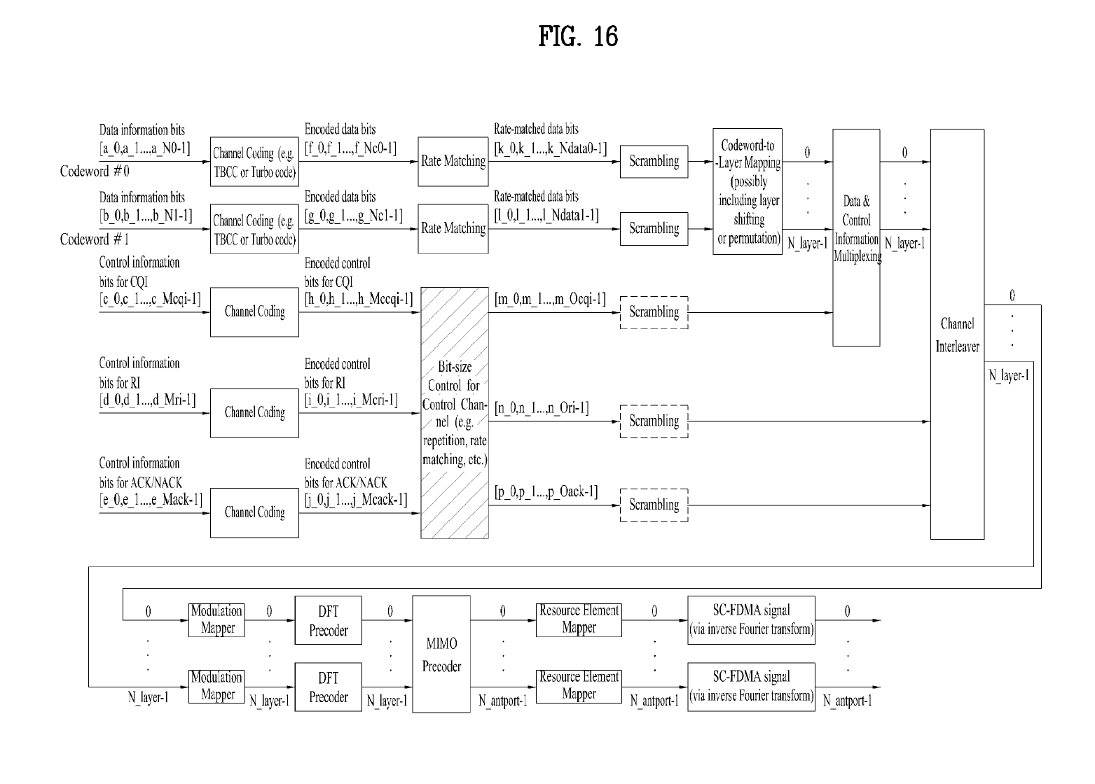

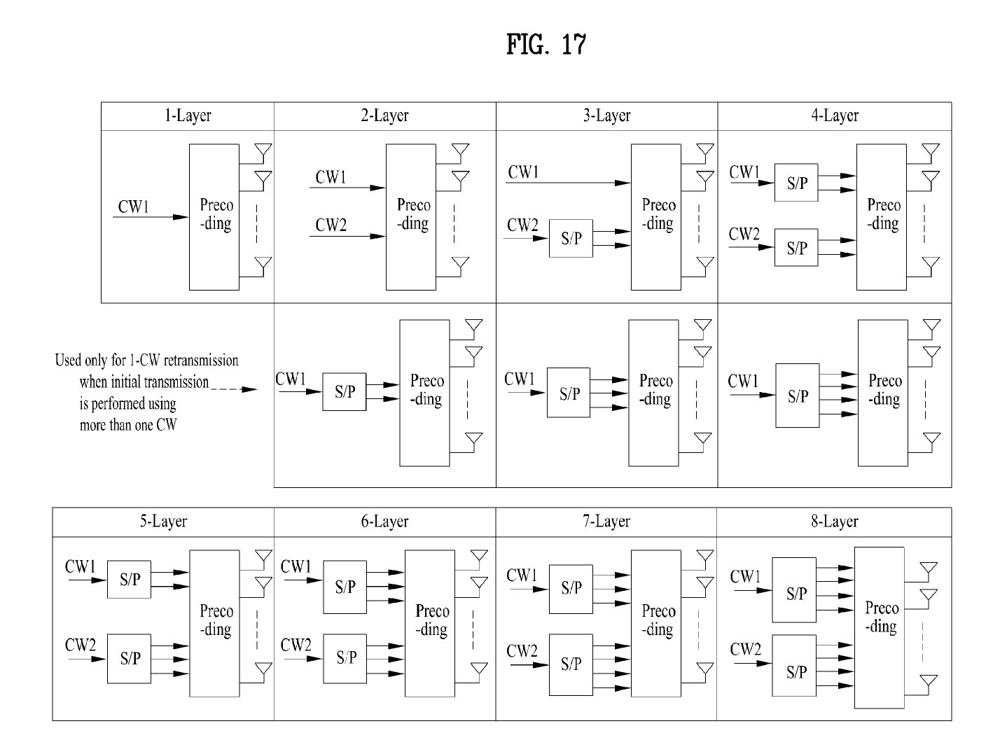

FIGS. 16 and 17 are views illustrating a plurality of UL-SCH transport blocks included in a UE and an exemplary method of multiplexing UCI and control information in the UE according to an embodiment of the present invention.

In FIGS. 16 and 17, although it is assumed for convenience that two codewords are transmitted, FIGS. 16 and 17 are applied even during transmission of one or three or more codewords. A codeword and a transport block correspond to each other. In this disclosure, the terms codeword and transport block are used interchangeably. Since a basic process is the same/similar as/to the process described with reference to FIGS. 13 and 14, a part related to MIMO will mainly be described herein.

Referring to FIGS. 16 and 17, each codeword is channel-coded and then rate-matched according to a given MCS table. The encoded bits are scrambled cell-specifically, UL-specifically, UE-specifically, or codeword-specifically. The scrambled codeword is mapped to a layer. Codeword-to-layer mapping may include, for example, layer shifting (or permutation). An example of codeword-to-layer mapping is illustrated in FIG. 17. The subsequent operation is the same/similar as/to the operation described previously except that the operation is performed in units of layers.

Notably, in the case of MIMO, MIMO precoding is applied to the output of DFT precoding. MIMO precoding serves to map/distribute a layer (or a virtual antenna) to a physical antenna. MIMO precoding is performed using a precoding matrix and may be implemented in a different order/position from the illustrated order/position.

UCI (e.g. CQI, PMI, RI, ACK/NACK, etc.) may be independently channel-coded according to a given scheme. The number of encoded bits is controlled by a bit-size controller (a hatched block). The bit-size controller may be included in a channel coding block. The bit-size controller may operate as follows.

1. The bit controller recognizes an RI (n_rank_pusch) for a PUSCH.

2. The rank of a control channel is set to n_rank_pusch (n_rank_ctrl=n_rank_pusch) such that the number of bits for the control channel, n_bit_ctrl, is extended to n_rank_ctrl*n_bit_ctrl (n_ext_ctrl=n_rank_ctrl*n_bit_ctrl). The operation of the bit-size is described as indicated in the following methods A and B.

A. The bit-size controller may extend bits of the control channel by simply repeating the bits of the control channel. For example, if bits of the control channel are [a0 a1 a2 a3] (i.e. n_bit_ctrl=4) and n_rank_pusch is 2, then extended bits of the control channel may be [a0 a1 a2 a3 a0 a1 a2 a3] (i.e. n_ext_ctrl=8).

B. The bit-size controller may extend bits of the control channel to n_ext_ctrl by applying circular buffer principle.

If the bit-size and the channel coding block are unified (e.g. in the case of CQI/PMI control channel), the encoded bits may be generated by applying channel coding and rate matching may be performed according to a legacy LTE rule.

In addition to the bit-size controller, bit-level interleaving may be applied to provide substantial layer randomization.

Restricting the rank of the control channel to the rank of the data channel is advantageous in terms of signaling overhead. If the ranks of the data and control channels are different, additional signaling of PMI for the control channel is necessary. In addition, using the same RI for the data and control channels serves to simplify a multiplexing chain. Accordingly, while an effective rank of the control channel is 1, a rank actually used to transmit the control channel may be n_rank_pusch. In terms of reception, a MIMO decoder is applied to each layer and LLR outputs are combined using Maximum Ratio Combining (MRC).

The CQI/PMI channel and data parts of two codewords are multiplexed by a data and control information multiplexing block. Next, a channel interleaver performs time-first mapping so that HARQ ACK/NACK information may be present on both slots in a subframe and may be mapped to resources around uplink DM-RSs.

Thereafter, modulation, DFT precoding, MIMO precoding, and RE mapping are performed with respect to the respective layers. Layer-specific scrambling may be added to ACK/NACK and RI scrambled to all layers. A specific codeword may be selected for UCI of CQI/PMI so as to be piggybacked.

2. Multi-Carrier Aggregation Environment

A communication environment considered in embodiments of the present invention includes all environments supporting multiple carriers. That is, a multi-carrier system or a CA system used in the present invention refers to a system using a plurality of carriers each having a narrower bandwidth than a target bandwidth in order to support a wideband.

In the present invention, multiple carriers indicate aggregation of CCs (or CA). In this case, CA refers to not only aggregation of contiguous carriers but also aggregation of non-contiguous carriers. Multi-carrier aggregation is used interchangeably with the term CA or bandwidth aggregation.

In an LTE-A system, the goal of multi-carrier aggregation (i.e. CA) in which two or more CCs are aggregated is to support a bandwidth of up to 100 MHz. When more than one carrier having a narrower bandwidth than a target bandwidth is aggregated, the bandwidth of each aggregated carrier may be restricted to a bandwidth used in a legacy system in order to maintain backward compatibility with a legacy IMT system.

For example, the legacy 3GPP LTE system may support bandwidths of {1.4, 3, 5, 10, 15, 20} MHz and the 3GPP LTE-A system may support a bandwidth wider than 20 MHz, using only the above bandwidths supported by the LTE system. The multi-carrier system used in the present invention may support CA by defining a new bandwidth irrespective of the bandwidths used in the legacy system.

The LTE-A system uses the concept of a cell to manage radio resources. The cell is defined as a combination of a downlink resource and an uplink resource and the UL resource may be selectively defined. Accordingly, the cell may be configured by the downlink resource alone or by the downlink resource and the uplink resource. When multiple carriers (i.e. CA) are supported, the linkage between the carrier frequency of the downlink resource (or DL CC) and the carrier frequency of the uplink resource (or UL CC) may be indicated by system information.

A cell used in the LTE-A system includes a Primary Cell (PCell) and a Secondary Cell (SCell). The PCell may refer to a cell operating on a primary frequency (e.g. Primary CC (PCC)) and the SCell may refer to a cell operating on a secondary frequency (or Secondary CC (SCC)). Notably, only one PCell and one or more SCells may be allocated to a specific UE.

The PCell is used to perform an initial connection establishment procedure or a connection re-establishment procedure. The PCell may refer to a cell indicated during a handover procedure. The SCell can be configured after Radio Resource Control (RRC) connection is established and may be used to provide additional radio resources.

The PCell and SCell may be used as a serving cell. In case of a UE in which CA is not configured or CA is not supported even in an RRC_CONNECTED state, only a single serving cell comprised of only a PCell is present. Meanwhile, in case of a UE in which CA is configured in an RRC_CONNECTED state, one or more serving cells may be present and all cells include a PCell and one or more SCells.

After an initial security activation procedure is started, an E-UTRAN may configure a network including one or more SCells in addition to an initially configured PCell during a connection establishment procedure. In a multi-carrier environment, each of a PCell and an SCell may serve as a CC. Namely, CA may be understood as a combination of a PCell and one or more SCells. In the following embodiments, a PCC may have the same meaning as a PCell and an SCC may have the same meaning as an SCell.

3. RI Information Encoding Method

Hereinafter, various methods for encoding RI information according to an embodiment of the present invention will be described in detail.

In the case where a UE multiplexes UCI and PUSCH data using a plurality of layers in a CA environment (i.e. a multi-CC environment), the UCI may be repeatedly mapped to all or partial layers. In mapping the UCI, especially, an RI to all or partial layers, methods for adjusting the amount of resources allocated to the RI by multiplexing the RI will be described hereinbelow.

3.1 RI Encoding Application Range

If an RI and PUSCH data are multiplexed in a CA environment (e.g. in a multi-layer or a single-layer environment), all RI information bits provided in multiple CCs may be encoded to a single codeword.

Since an RM code in a legacy LTE system (Rel-8 or Rel-9) or an LTE-A system (Rel-10) supports only up to 13 information bits in case of an uplink control channel or only up to 11 information bits in case of an uplink shared channel, the RM code is extended or a new channel coding scheme (e.g. Tail-Biting Convolutional Code (TBCC)) may be applied, during encoding. In this case, the channel coding or encoding scheme may be differently applied according to the size of the information bits.

For example, if RI information has a size of 1 or 2 bits, an encoding scheme used in the legacy LTE system may be applied and, if RI information has a size of 3 to 11 bits, a (32,O) RM code may be applied. If the size of the RI information bits is 12 bits or more, TBCC may be applied.

3.2 CC Grouping Method

If an RI and PUSCH data are multiplexed in a CA environment (e.g. in a multi-layer or a single-layer environment), a method for dividing RI information bits provided in multiple CCs into two or more groups and encoding each group to one codeword may be considered.

In this case, a channel coding or encoding scheme of the legacy LTE system (Rel-8 or Rel-9) or an LTE-A system (Rel-10) may be applied or a new channel coding or encoding scheme may be applied. The new channel coding or encoding scheme may be differently applied according to the size of RI information bits.

For example, if RI information has a size of 1 or 2 bits, an encoding scheme used in the legacy LTE system may be applied and, if RI information has a size of 3 to 11 bits, a (32,O) RM code may be applied. If the size of the RI information is 12 bits or more, TBCC may be applied.

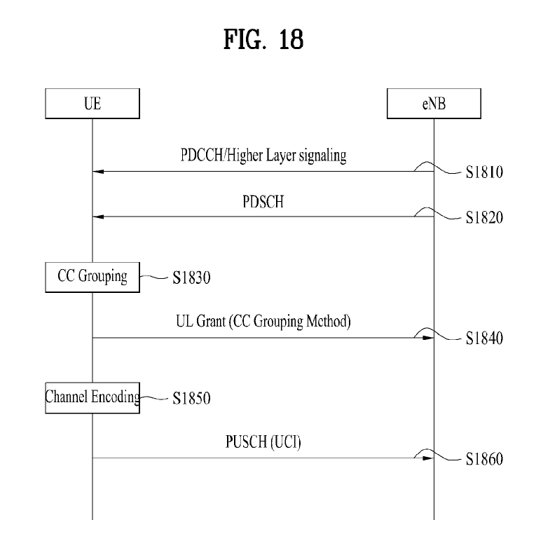

FIG. 18 is a view illustrating an exemplary method for transmitting UCI by grouping multiple CCs according to an embodiment of the present invention.

Referring to FIG. 18, a UE may acquire information about multiple CCs from an eNB through higher layer signaling (e.g. RRC signaling) or through a PDCCH signal. In embodiments of the present invention, a minimum of one CC to a maximum of 5 CCs are assumed as multiple CCs (S1810).

The eNB may transmit PDSCH data to the UE through multiple CCs (S1820).

The UE may generate UCI for the PDSCH data transmitted through the multiple CCs. If a maximum of 5 CCs is included in the multiple CCs, an RI value may be extended up to 15 bits. Then, it may be difficult for the UE to transmit the RI value to the eNB by a scheme used in the legacy LTE system. Accordingly, the UE and/or eNB may group the multiple CCs according to various methods in order to multiplex the RI value of a large size with the PUSCH data (S1830).

In addition, the UE may inform the eNB of grouping information about grouped CCs through a UL grant. The grouping information may include grouping method information as to how respective CCs are grouped and include CC information per group (S1840).

The UE may channel-encode RI values for grouped CCs along with uplink data. The channel encoding method may refer to the methods described with reference to FIGS. 2, 4, 13, and 16 (S1850).

The UE may transmit the PUSCH data generated in step S1850 to the eNB (S1860).

Hereinafter, various methods for grouping multiple CCs in order to group information bits of an RI in step 51830 will be described in detail.

3.2.1 Method for Dividing a Plurality of CCs into Two Groups

3.2.1.1 Group Configuration Method-1

The UE may select one PCC (i.e. a PCell) from among multiple CCs to configure the PCC as one group and may group the other CCs as the other group. The UE may transmit an index of the PCC to the eNB through a UL grant or a channel as in step S1840. The method for selecting the PCC is as follows.
The first CC or the last CC may be selected as the PCC from among multiple CCs. Alternatively, the PCC may be a CC configured fixedly by the LTE-A system or the UE.
A CC having the best channel quality or a CC having the worst channel quality among the multiple CCs may be configured as the PCC.
The PCC may be a CC having the largest RI information bit size or a CC having the smallest RI information bit size. If the sizes of RI information bits in the multiple CCs are the same, the first or the last CC among the multiple CCs may be configured as the PCC.
A CC having the highest RI coding rate or a CC having the lowest RI coding rate may be configured as the PCC. If the coding rates of RIs are the same, the first CC or the last CC among the multiple CCs may be selected as the PCC.
The PCC may be a CC having the highest or lowest modulation order among the multiple CCs. If the modulation orders for the RIs among the multiple CCs are the same, the first or last CC among the multiple CCs may be selected as the PCC.
The PCC may be a CC having the largest or smallest Transport Block Size (TBS) of uplink data among the multiple CCs. If the TBSs of the uplink data among the multiple CCs are the same, the first or the last CC among the multiple CCs may be configured as the PCC.
The PCC may be a CC designated by the eNB in a previous subframe or in a frame prior to a plurality of frames among the multiple CCs.

3.2.1.2 Group configuration method-2

The UE may select two PCCs from among multiple CCs to configure the two PCCs as one group and may configure the other CCs as the other group. The UE may transmit indexes of the PCCs to the eNB through a UL grant or a UL channel (refer to S1840). The method for selecting the PCCs may apply the same method described in section 3.2.1.1, except that two PCCs rather than one PCC are sequentially designated in order of the most suitable condition.

The PCC group and the other CC group described in sections 3.2.1.1 and 3.2.1.2 may have different channel coding types, coding rates, and/or encoded bit sizes.

3.2.2 Method for dividing CCs into three groups

3.2.2.1 Group configuration method-1

The UE and/or eNB may configure two PCCs among multiple CCs as a group per PCC and may encode each PCC to one codeword and the other CCs (e.g., three CCs) to one codeword. The method for configuring the PCCs may use the method described in Section 3.2.1.2.

3.2.2.2. Group configuration method-2

Since the LTE-A system needs to cover a bandwidth of 100 MHz, a maximum of 5 CCs may be included in multiple CCs. In this case, the UE may sequentially configure (two CCs, two CCs, one CC), (two CCs, one CC, two CCs), or (one CC, two CCs, two CCs) as respective groups. CCs in each group may be encoded to one codeword. The method for dividing CCs into groups may be as follows.
Groups of multiple CCs may be configured irrespective of external conditions according to LTE-A specification or a scheme pre-designated by the UE.
Groups of the multiple CCs may be divided in order of good channel quality or bad channel quality according to channel quality.
If sizes of RI information allocated to respective multiple CCs differ, groups may be divided in order of a large amount of information or a small amount of information according to the size of the RI information. In this case, each UE may group the CCs such that the difference in the sum of the sizes of RI information between respective groups becomes the smallest.
The UE may group the multiple CCs in order of a high coding rate or a low coding rate according to the coding rate of an RI. The UE may group the CCs such that the difference in a coding rate between respective groups becomes the smallest.
According to the embodiments of the present invention, the respective CC groups may be configured according to a method designated by the eNB in an immediately previous subframe or a subframe prior to a plurality of frames.

The respective groups described in sections 3.2.2.1 and 3.2.2.2 may have different channel coding types, coding rates, and/or encoded bit sizes.

3.2.3 Method for Dividing CCs into Four Groups

3.2.3.1 Group Configuration Method-1

Methods for diving RI information bits into four groups may be meaningful only when 5 CCs are included in multiple CCs. If 5 CCs are used in a network, the UE may select two CCs to configure the two CCs as one group and may configure the other CCs as a group per CC. In this case, the UE may encode RI information bits to a different codeword per group.

The method for selecting two CCs may be as follows.
Two CCs may be CCs configured fixedly by the LTE-A system or the UE.
Two CCs having the best channel quality or two CCs having the worst channel quality among the multiple CCs may be configured as the two CCs.
Two CCs having the largest size of RI information bits or the smallest size of the RI information bits may be configured. If the sizes of the RI information bits in the multiple CCs are the same, two CCs having the highest index or two CCs having the lowest index may be configured.
Two CCs may be configured as CCs having the highest RI coding rate or the lowest RI coding rate. If the coding rates of RIs are the same, two CCs having the lowest index or the highest index may be configured.
Two CCs may be configured as CCs having the highest modulation order or the lowest modulation order. If the modulation orders for the RIs of multiple CCs are the same, two CCs having the highest index or the lowest index may be configured.
Two CCs may be configured as CCs having the largest TBS of uplink data or the smallest TBS of the uplink data in the multiple CCs. If the TBSs of the uplink data are the same, two CCs having the highest or lowest index may be configured.
The two CCs may be CCs designated by the eNB among multiple CCs in an immediately previous subframe or a subframe prior to a plurality of frames.

3.2.3.1 Group Configuration Method-2

If an RI and PUSCH data are multiplexed (e.g., in a multi-layer or single-layer environment) in a multi-CC environment (e.g., in a CA environment), a UE may encode information bits of an RI given in multiple CCs to each codeword per CC.

In this case, a channel coding or encoding scheme of the legacy LTE system (Rel-8 or Rel-9) or an LTE-A system (Rel-10) may be applied or a new channel coding or encoding scheme may be applied. The newly applied channel coding or encoding scheme may be differently applied according to the size of RI information bits.

4. Method for Configuring Representative RI Value

In a multi-CC environment, the UE and/or eNB may select a representative RI value which can represent. RI values of a plurality of CCs from among the RI values and may transmit only the representative RI value. Hereinafter, a method for transmitting UCI including the representative RI values will be described in detail.

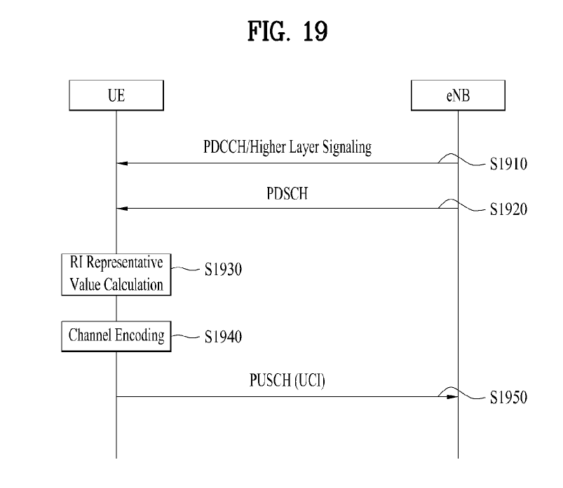

FIG. 19 is a view illustrating an exemplary method for transmitting UCI using representative RI information according to an embodiment of the present invention.

Referring to FIG. 19, a UE may acquire information about multiple CCs from an eNB through higher layer signaling (e.g., RRC signaling) or through a PDCCH signal. In this case, it is assumed in the embodiments of the present invention that a minimum of one CC to a maximum of five CCs are included in the multiple CCs (S1910).

The eNB may transmit PDSCH data to the UE through the multiple CCs to transmit downlink data (S1920).

The UE may generate UCI about the PDSCH data transmitted on the multiple CCs. At this time, the UE may calculate a representative RI for multiple CCs in order to transmit the UCI to the eNB. For example, the UE may select a representative RI value capable of representing RI values for the multiple CCs when using the multiple CCs and may transmit the representative RI value to the eNB (S1930).

The UE may perform channel encoding to multiplex the representative RI value and PUSCH data. The channel encoding method may refer to the methods described with reference to FIGS. 2, 4, 13, and 16 (step S1940).

The UE may transmit the PUSCH data generated in step S1940 to the eNB (S1950).

Hereinafter, various methods for obtaining the representative RI value in step S1930 will be described in detail.
The representative RI value may be configured as an average value of RI values corresponding to multiple CCs. Although the RI values in the LTE-A system are defined only as integers, the average of the RI values may not be an integer. According to the embodiments of the present invention, if the average of the RI values is not an integer, an integer most closely approximating the average value may be selected as the representative RI value. For example, if RI values given in 5 CCs are 4, 5, 3, 5, and 2, the average thereof is 3.8 (=19/5) and an integer most closely approximating the average value is 4. Accordingly, 4 may be selected as the representative RI value.
A value that occurs most frequently among RI values corresponding to CCs allocated to the UE may be configured as the representative RI value. That is, the most frequently occurring value among the RI values of all CCs may be configured as the representative RI value. For example, if RI values given in 5 CCs are 4, 5, 3, 5, and 2, ‘5’ occurs twice, whereas the other values occur once and thus ‘5’ may be configured as the representative RI value.
The representative RI value may use a median value of RI values corresponding to multiple CCs allocated to the UE. Namely, a value corresponding to a median value in order of size among the RI values of all CCs may be used as the representative RI value. For example, if RI values given in 5 CCs are 4, 5, 3, 5, and 2, then ‘3’ corresponding to the third place which is a median of the RI size values may be configured as the representative RI value.
A maximum or minimum value of the RI values of the multiple CCs allocated to the UE may be configured as the representative RI value. For example, if RI values given in 5 CCs are 4, 5, 3, 5, and 2, a maximum value ‘5’ or a minimum value ‘2’ may be configured as the representative RI value.
An RI value of a CC having the largest TBS or an RI value of a CC having the smallest TBS among multiple CCs allocated to the UE may be configured as the representative RI value.
An RI value of a CC having the highest MCS level or an RI value of a CC having the lowest MCS level among multiple CCs allocated to the UE may be configured as the representative RI value.
An RI value of a CC designated by the UE and/or the eNB among multiple CCs allocated to the UE may be configured as the representative RI value.

5. Method for Grouping Multiple CCs and Configuring Representative RI Value

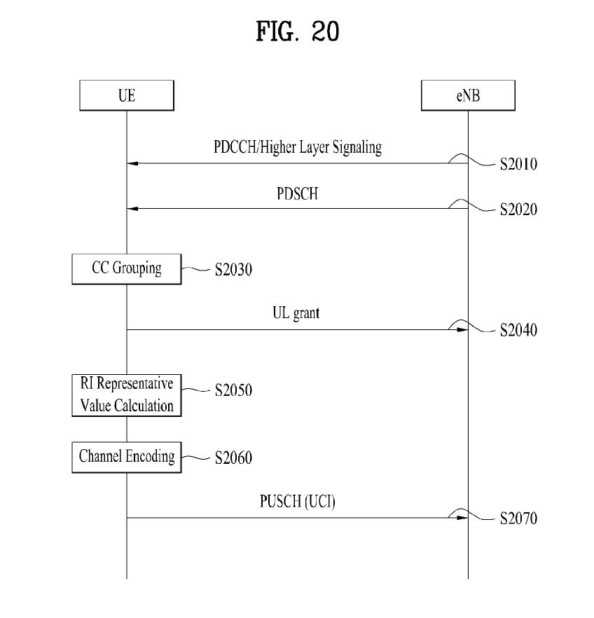

FIG. 20 is a view illustrating an exemplary method for grouping multiple CCs and selecting a representative RI value to transmit UCI according to an embodiment of the present invention.

Hereinafter, a method using a combination of the methods described with reference to FIGS. 18 and 19 will be described. If two or more CCs are allocated to the UE, the UE and/or the eNB may group the CCs, select a representative RI value of each group, and multiplex the representative RI value and PUSCH data, thereby transmitting the multiplexed data.

Referring to FIG. 20, the UE may acquire information about multiple CCs from the eNB through higher layer signaling (e.g. RRC signaling) or through a PDCCH signal. In this case, it is assumed in the embodiments of the present invention that a minimum of one CC to a maximum of 5 CCs are included in the multiple CCs (step S2010).

The eNB may transmit PDSCH data to the UE through the multiple CCs (step S2020).

The UE may generate UCI for the PDSCH data transmitted through the multiple CCs. If a maximum of 5 CCs is included in the multiple CCs, an RI value may be extended up to 15 bits. In this case, it may be difficult to transmit an RI value to the eNB using a method used in the legacy LTE system. Therefore, the UE and/or the eNB may group multiple CCs according to various methods in order to multiplex an RI value of a large size and PUSCH data. The methods for grouping the multiple CCs may refer to the methods described in FIG. 18 and section 3.2 (S2030).

The UE may inform the eNB of information about RI values of the grouped CCs (S2040).

In addition, the UE may select a representative RI value of each group divided in step S2030. The RI value of each group may be calculated based on the methods described with reference to FIG. 19 (step S2050).

In FIG. 20, the order of step S2040 and step S2050 may be changed. If step S2040 is performed prior to step S2050, a UL grant may include information about grouping of multiple CCs and/or information as to whether the representative RI value is used. If step S2040 is performed after step S2050, the UL grant may include the calculated representative RI value per group and/or information about CCs corresponding to the representative RI value.

The UE may channel-encode the representative RI values of the CC groups along with uplink data. The channel encoding method may refer to the methods described with reference to FIGS. 2, 4, 13, and 16.

The UE may transmit PUSCH data generated in step S2060 to the eNB (S2070).

6. CRC Application Method During Transmission of UCI

In using the methods proposed in sections 3 to 5, one consideration is whether to apply a CRC. The following four types of CRC schemes are used in the LTE system.

(1) g_{CRC24A}(D)=[D²⁴+D²³+D¹⁸+D¹⁷+D¹¹+D¹⁰+D⁷+D⁶+D⁵+D⁴+D³+D+1]

(2) g_{CRC24B}(D)=[D²⁴+D²³+D⁶+D⁵+D+1]

(3) g_{CRC16}(D)=[D¹⁶+D₁₂+D⁶+1]

(4) g_{CRC8}(D)=[D⁸+D⁷+D⁴+D³+D+1]

The schemes (2), (3), and (4) are used when the size L of the CRC is 24 bits, 16 bits, and 8 bits, respectively. CRC application methods while performing channel coding upon UCI (e.g. CQI/PMI, ACK/NACK, or RI) will now be described.

6.1 CRC Application Method-1

When a UE channel-codes UCI in a multi-CC environment, a CRC per CC may be applied to UCI corresponding to each CC.
CRCs of the same size may be applied as CRCs for UCI of the respective CCs.
CRCs of different sizes or CRCs of the same size and different types for UCI of a specific CC or CCs may be applied as CRCs for UCI of the respective CCs.
CRCs of different sizes or CRCs of the same size and different types may be applied according to a type of UCI (CQI/PMI, HARQ-ACK, or RI) as CRCs for UCI of the same CCs.

6.2 CRC Application Method-2

In channel-coding UCI in a multi-CC environment, a UE may group CCs and then apply a CRC per group.
The method for grouping each CC in multiple CCs is referred to in section 3.2.
A part of PCCs and SCCs may be configured as one group. A group including the PCCs and SCCs may be configured as a PCC group.
UCI of grouped CCs may be joint-encoded using one channel encoder. In this case, a CRC may be applied to UCI of the joint-encoded CC group one by one.
As CRCs for UCI of respective CC groups, CRCs of different sizes or CRCs of the same size and different types may be applied to UCI of a specific CC group or CC groups.
CRCs of different sizes or CRCs of the same size and different types may be applied according to a type of UCI (CQI/PMI, HARQ-ACK, or RI) as CRCs for UCI of the same CC groups.

6.3 CRC Application Method-3

In channel-encoding UCI in a multi-CC environment, the UE may apply a CRC only to partial CCs or partial CC groups.
Whether to apply a CRC may be determined according to the size of information bits of each UCI or the type of applied channel coding. Also, whether to apply the CRC may differ according to the types of UCI even when the UCI belongs to the same CC or the same CC group.
The method for grouping each CC in multiple CCs may refer to section 3.2.
A part of PCCs and SCCs may be configured as one group. In this case, a group including the PCCs and SCCs may be configured as a PCC group.
UCI of grouped CCs may be joint-encoded using one channel encoder. In this case, a CRC may be applied to UCI of the joint-encoded CC group one by one.
As CRCs for UCI of respective CC groups, CRCs of different sizes or CRCs of the same size and different types may be applied to UCI of a specific CC group or CC groups.
CRCs of different sizes or CRCs of the same size and different types may be applied according to a type of UCI (CQI/PMI, HARQ-ACK, or RI) as CRCs for UCI of the same CC groups.

6.4 CRC Application Method-4

In channel-encoding UCI in a multi-CC environment, the UE may apply one CRC to the UCI of all CCs.

The size of an applied CRC may differ according to the type of UCI. Even when CRCs have the same size, different types of CRCs may be applied according to types of UCI. In a special case, a CRC may be applied only to partial UCI and may not be applied to specific UCI.

6.5 CRC Application Method-5

Hereinafter, a method using a combination of the CRC application methods described in section 6.2 to 6.4 will be described.
The UE may apply a CRC to UCI of each of all CCs included in multiple CCs and, thereafter, additionally apply a CRC to the entire UCI. The CRC applied to the UCI of each CC and the CRC applied to the entire UCI may have different sizes or different types of the same size.
The UE may apply a CRC to UCI of each of all CCs included in multiple CCs and, thereafter, additionally apply a CRC to UCI belonging to each CC group. The CRC applied to the UCI of the CC and the CRC applied to the UCI of the CC group may have different sizes or different types of the same size.
The UE may apply a CRC to UCI of each of all CC groups and, thereafter, additionally apply a CRC to the entire UCI. The CRC applied to the UCI of the CC group and the CRC applied to the entire UCI may have different sizes or different types of the same size.
CRCs may be applied to each CC, CC groups, and all CCs. That is, a CRC may be applied to UCI of each CC, may be additionally applied to each CC group, and may be finally applied to all CCs.

6.6 CRC Application and Channel Coding Method

Channel coding for the CRC application method described in section 6.5 may be performed as follows.
Channel coding may be applied to every step in which the CRC is applied. For example, if the CRC is additionally applied to all CCs after being applied to UCI of each CC, the UE may perform channel coding upon each CC and may perform additional channel coding upon all CCs.
Channel coding may be applied to one or a part of steps in which the CRC is applied. For example, if the CRC is additionally applied to UCI of all CCs after being applied to UCI of each CC, the UE may perform channel coding only upon UCI corresponding to each CC or upon UCI and CRCs of all CCs.

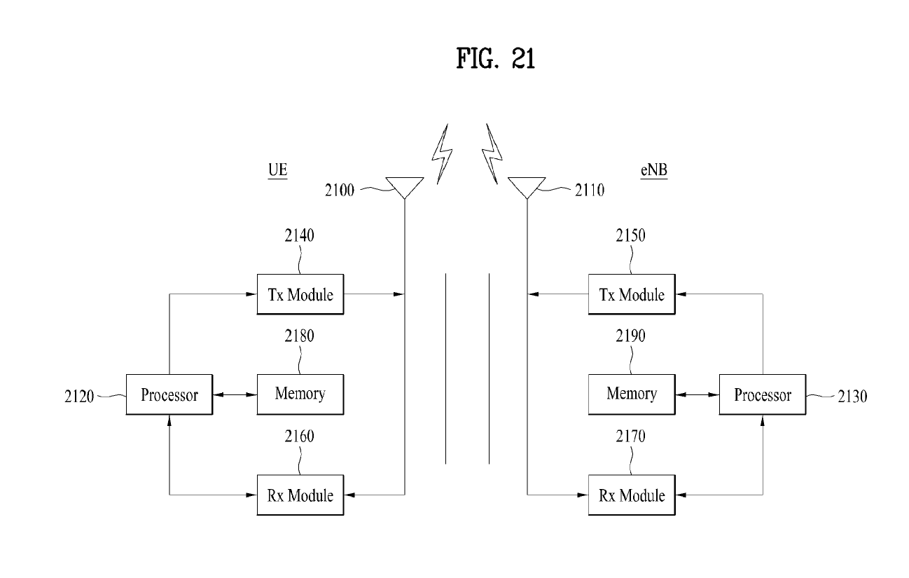

FIG. 21 is a view illustrating a UE and an eNB in which the embodiments of the present invention described with reference to FIGS. 1 to 20 can be performed, according to another embodiment of the present invention.

The UE may operate as a transmitter in uplink and as a receiver in downlink. The eNB may operate as a receiver in uplink and as a transmitter in downlink.

The UE and eNB may include Transmission (Tx) modules 2140 and 2150 and Reception (Rx) modules 2160 and 2170, respectively, for controlling transmission and reception of information, data, and/or messages, and may include antennas 2100 and 2110, respectively, for transmitting and receiving the information, data, and/or messages. The UE and eNB may include processors 2120 and 2130 for performing the above-described embodiments of the present invention and memories 2180 and 2190 for temporarily or permanently storing a processing procedure performed by the processors, respectively. The UE and eNB of FIG. 21 may further include one or more of an LTE module and a low-power Radio Frequency (RF)/Intermediate Frequency (IF) module to support the LTE system and the LTE-A system.

The Tx modules and Rx modules included in the UE and the eNB may perform a packet modulation/demodulation function for data transmission, a quick packet channel coding function, Orthogonal Frequency Division Multiple Access (OFDMA) packet scheduling, Time Division Duplex (TDD) packet scheduling, and/or a channel multiplexing function.

The apparatus described in FIG. 21 is a means for implementing the methods described with reference to FIGS. 1 to 20. The embodiments of the present invention may be performed using constituent elements and functions of the aforementioned UE and eNB. The apparatus described with reference to FIG. 21 may further include the configurations of FIGS. 2 to 4 and, more preferably, the processors may further include the configurations of FIGS. 2 to 4.

The processor of the UE may receive a PDCCH signal by monitoring a search space. Specifically, an LTE-A UE may receive a PDCCH without blocking the PDCCH signaling with another LTE UE by performing blind decoding upon an extended Common Search Space (CSS).

Meanwhile, the UE in the present invention may be any of a Personal Digital Assistant (PDA), a cellular phone, a Personal Communication Service (PCS) phone, a Global system for Mobile (GSM) phone, a Wideband CDMA (WCDMA) phone, a Mobile Broadband System (MBS) phone, a hand-held PC, a notebook PC, a smartphone, a Multi Mode-Multi Band (MM-MB) terminal, etc.

The smartphone is a terminal providing the advantages of both a mobile communication terminal and a PDA and may refer to a terminal in which data communication functions such as scheduling management, fax transmission and reception, and Internet access, which are functions of the PDA, are incorporated into the mobile communication terminal. The MM-MB terminal refers to a terminal which has a multi-modem chip therein and which can operate in any of a mobile Internet system and other mobile communication systems (e.g., a CDMA 2000 system, a WCDMA, etc.).

The embodiments of the present invention may be achieved by various means, for example, hardware, firmware, software, or a combination thereof.

In a hardware configuration, the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be achieved by a module, a procedure, a function, etc. performing the above-described functions or operations. For example, software code may be stored in the memory units 1280 and 1290 and executed by the processors 1220 and 1230. The memory units are located at the interior or exterior of the processor and may transmit data to and receive data from the processor via various known means.

The embodiments of the present invention may be carried out in other specific ways without departing from the spirit and essential characteristics of the present invention. Accordingly, the above detailed description is therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. Also, claims that are not explicitly cited in the appended claims may be presented in combination as an exemplary embodiment of the present invention or included as a new claim by subsequent amendment after the application is filed.

### INDUSTRIAL APPLICABILITY

The embodiments of the present invention may be applied to various wireless access systems, for example, a 3GPP LTE system, a 3GPP LTE-A system, a 3GPP2 system, and/or an IEEE 802.xx system. The embodiments of the present invention may be applied not only to the above various wireless access systems but also to all technical fields employing the various wireless access systems.

1. A method for transmitting Uplink Control Information (UCI) at a user equipment in a wireless access system, the method comprising:
receiving information about one or more cells allocated in a multi-cell environment;
calculating representative Rank Indicator (RI) information for the one or more cells;
channel-encoding uplink data and UCI containing the representative RI information; and
transmitting a Physical Uplink Shared Channel (PUSCH) signal which includes the UCI containing the representative RI information.

2. The method according to claim 1, wherein the representative RI information is configured according to a Transport Block Size (TBS) for the one or more cells.

3. The method according to claim 1, wherein the representative RI information is configured according to a Modulation Coding Scheme (MCS) level for the one or more cells.

4. The method according to claim 1, wherein the representative RI information is configured as an RI value for a cell designated by the user equipment or a base station among the one or more cells.

5. A method for receiving Uplink Control Information (UCI) at a base station in a wireless access system, the method comprising:
transmitting information about one or more cells in a multi-cell environment; and
receiving a Physical Uplink Shared Channel (PUSCH) signal which includes UCI containing representative Rank Indicator (RI) information for the one or more cells.

6. The method according to claim 5, wherein the representative RI information is configured according to a Transport Block Size (TBS) for the one or more cells.

7. The method according to claim 5, wherein the representative RI information is configured according to a Modulation Coding Scheme (MCS) level for the one or more cells.

8. The method according to claim 5, wherein the representative RI information is configured as an RI value for a cell designated by a user equipment or the base station among the one or more cells.
